(19) United States
(12) Patent Application Publication
(10) Pub. No.: US 2012/0243958 A1
(43) Pub. Date: Sep. 27, 2012

(54) Vehicle transportation system on the highway

(75) Inventor: Yixin Guo, Suzhou City (CN)

(73) Assignee: Xingkang Computer Technology (Suzhou) Co., Ltd., Suzhou City (CN)

(21) Appl. No.: 13/341,902

(22) Filed: Dec. 30, 2011

(30) Foreign Application Priority Data
Mar. 21, 2011 (CN) PCT/CN2011/071996

(51) Int. Cl. B60P 3/073; B62D 53/06

(52) U.S. Cl. 410/30; 280/423.1; 280/424

(57) ABSTRACT

The invention presents a vehicle transportation system on the highway. This system can transfer the moving vehicles such as cars, sport utility vehicles (SUVs), and multi-purpose vehicles (MPVs) from one site of the highway to another site. The system can decrease fuel consumption and lower the amount of the exhausts from the vehicles for good environment protection. It also cuts the operating cost for the vehicles' owners.

### CROSS-REFERENCE TO RELATED APPLICATIONS

This application claims the benefit to the PCT Application No. PCT/CN2011/071996, filed on Mar. 21, 2011, in China, which is incorporated by reference herein in its entirety.

### FIELD OF THE INVENTION

The invention presents a vehicle transportation system on the highway. This system is to transfer the moving vehicles such as cars, SUVs (sports utility vehicle), MPVs (multi-purpose vehicle), or any other types of vehicles from one site the highway to another site. This way the system can save fuels and decrease the amount of exhausts such as carbon dioxide. At the same time, it cuts the operation costs for the vehicles' owners.

### BACKGROUND OF THE INVENTION

The development of the highway brings convenience for the society and also stimulates the economic development. The more vehicles run on the highway, the higher demands for the fuel supply. As a result, the cost to operate vehicle remains high and the exhausts such as carbon monoxide and carbon dioxide cannot be dropped. No such a transportation system exists in the world to carry moving vehicles such as SUVs, MPVs, and any other vehicles, which is classified as ‘vehicle or vehicles’ in this invention, from one site of the highway to another site. The governments in the world are only focused on the development of moving vehicles instead of having a system to transfer moving vehicles as a whole.

To solve these problems, a new transportation system has been presented in this invention. The invention can save energy consumption, decrease environment pollution, and cut the operating costs for the vehicles' owners.

### SUMMARY OF INVENTION

A transporting system to transfer moving vehicles on the highway is described in the invention. The system includes a truck that can be used to carry the vehicles, loading and unloading systems, position-setting setups, switching lanes that can switch driving direction of the truck, and platforms.

The truck has a power device providing power to move the truck itself forward, a chassis, carriages, and electrical device and accessories. The number of the carriages can be one or more than one, and every carriage can have one or two floors. In each floor there are available seats to park the carried vehicles.

Loading and/or unloading systems are to load and/or unload the vehicles. The loading and unloading systems have one or more than one sloping benches that include supporting structures and inclined planes. Three different types of sloping benches, that is, fixed, moving, and truck-carried sloping benches, have been presented in the invention.

Position-setting setups fix the carried vehicles during transportation. A position setting setup includes one setup to fix the tire of the carried vehicles and another setup to clamp the roofs of the carried vehicles. The setup to fix the tire can be a wedge or blocking rod assembly. The wedge or blocking rod assembly can be locked with the chassis. Side surfaces of the wedge or blocking rod of the rod assembly is in contact with the car wheels. Another setup to clamp the roofs of the carried vehicles is a cylinder device to clamp the carrier vehicle from the top.

Switching lanes that are located in any site of the highway can switch the driving direction for the transportation system. The lane can be in a format of either tunnel under the ground or an overhead bridge.

Platforms have gas and/or charging stations and are to provide gasoline and electricity. The electricity of the charging station can be from either wind energy or solar energy. The platforms can be built on any stop site of the highway.

In summary, the invention of this transportation system, which can transport the cars, SUV, and small load vehicles, includes a carrying truck, loading and unloading systems, positioning setting setups, switching lanes, and platforms. This system is to transfer moving vehicles from one site of the highway to another site. The invention on vehicle transportation can save the fuel consumption, decrease the harmful exhausts, and cut the operation cost for the vehicles' owners.

### BRIEF DESCRIPTION OF THE DRAWINGS

FIG. 1 is the diagram of the carrying truck.

FIG. 2 is the diagram of vehicle loading process to the carrying truck with fixed sloping bench.

FIG. 3 is the diagram of vehicle unloading process from the carrying truck with fixed sloping bench.

FIG. 4 is the diagram of vehicle loading process to the carrying truck with moving sloping bench.

FIG. 5 is the diagram of vehicle unloading process from the carrying truck with moving sloping bench.

FIG. 6 is the diagram of vehicle unloading process to a carrying truck having two floors with two moving sloping benches.

FIG. 7 is the diagram of vehicle unloading process from a carrying truck having two floors with one fixed and one moving sloping benches.

FIG. 8 is the diagram of vehicle unloading process from an adjustable sloping bench.

FIG. 9 is the diagram of vehicle unloading process from a folding sloping bench.

FIG. 10 is the diagram of vehicle loading process to a carrying truck having a hinged sloping bench.

FIG. 11 is the diagram of vehicle unloading process from a carrying truck having a hinged sloping bench.

FIG. 12 is the diagram of principle of a position-setting setup by a wedge block.

FIG. 13 is the diagram of the principle of position-setting setup by a cylinder.

FIG. 14 is the diagram of platform of a carrying truck and the principle of switching lane.

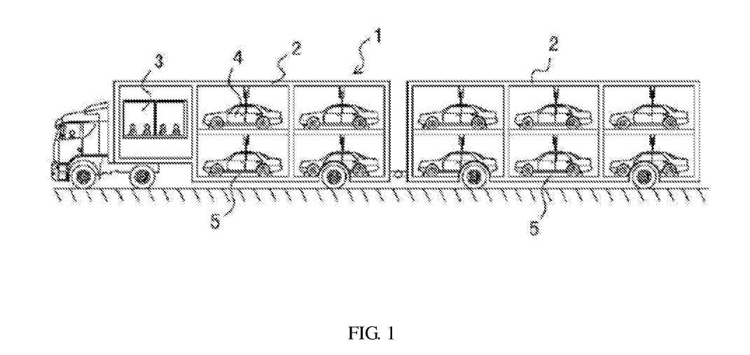

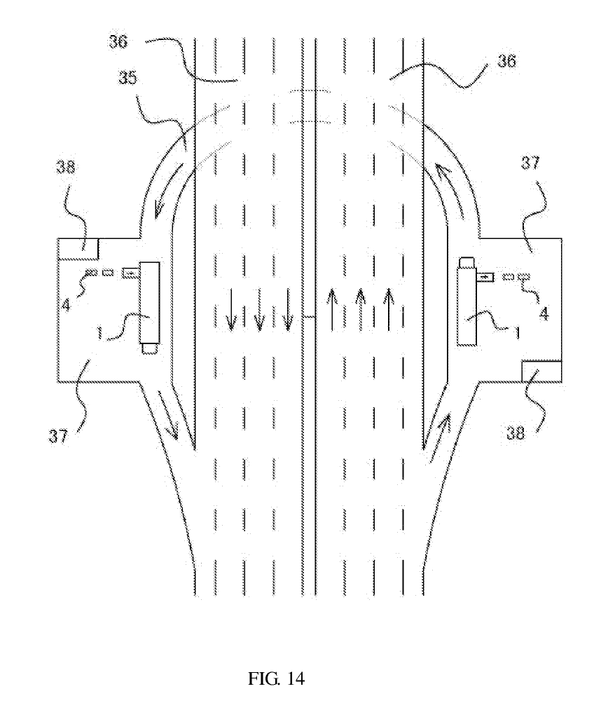

Labels from 1 to 40 cited in FIG. 1 to FIG. 14 are listed as the below for clarification: 1. Carrying truck; 2. Carriage; 3. V.I.P. lobby; 4. Vehicle; 5. Vehicle parking space; 6. Fixed sloping bench; 7. Moving sloping bench; 8. Rolling wheel; 9. Adjustable plate; 10. Track; 11. Accommodating space; 12. Guiding pulley; 13. Chain; 14. Chain wheel; 15. The first electric motor; 16. Drag point; 17. Inclined plane; 18. Folding plate; 19. Guiding rail; 20. The first air or hydraulic cylinder; 21. Guiding wheel; 22. Hinged plate; 23. The second Electric motor; 24. Fixed pulley; 25. Wire or rope; 26. Rolling wheel; 27. Wedge block; 28. Blocking rod; 29. Convex teeth; 30. Concave-shaped cut; 31. Concave space; 32. The 2nd air or hydraulic cylinder; 33. Press plate; 34. Lifting structure; 35. Tunnel; 36. Highway; 37. Platform; 38. Gas or charging station.

### DETAIL DESCRIPTION OF THE INVENTION

The invention is to present a highway transportation system to transfer moving cars, SUVs and MPVs (multi-purpose Vehicle). The transportation system includes a truck, loading and unloading systems, position-setting setups to hold the vehicles in position, switching lanes to switch driving direction, and platforms to provide services for parking and supply gasoline and electricity.

The carrying truck, as shown in FIG. 1, can carry and transfer the moving vehicles 4, which is loaded in vehicle parking space 5. The truck has its power plant, chassis, carriages 2, and electrical devices. Either an internal-combustion engine or electromotor can provide the power for the power plant in the invention. The internal-combustion engine can be either diesel or gasoline engine. An electromotor is better for environment protection than an internal combustion engine because of its negligible exhaust. The chassis provides space for the engines and all other necessary components such as power plant, carriages, and electrical devices, as stated before, to form a truck. The chassis itself is driven by the engines. The truck also has its transmission, wheel, and brake system, etc. that are necessary for a normal vehicle. The truck can have one or more than one carriages. Every carriage can have one or two floors. FIG. 1 shows one embodiment that one truck has two carriages 2 and each carriage has two floors. In the front section of the truck 1, there are two separate rooms: one is for the drivers and the other is the V.I.P. (very important person) lobby 3. For the truck with internal combustion engine, the power supplies can be batteries and/or power generator. Power consumption devices of the truck are an engine initiation system, an ignite system, and any other devices that need power. For the electro-driven truck, the power supply can be batteries and power consumption devices include devices for lighting and control.

The sloping bench is to load and/or unload the vehicle 4. The sloping bench has a supporting structure and an inclined surface. There are three different types of sloping benches depending on the connections between the supporting structure and inclined surface. Three different types of sloping benches are fixed sloping bench 6, moving sloping bench 7, and truck-carried sloping bench.

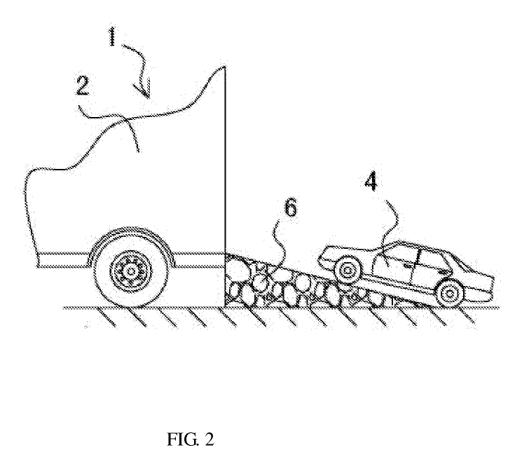

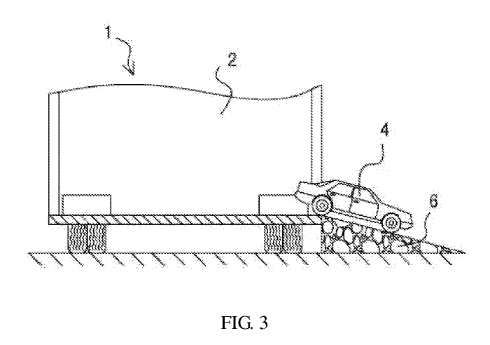

As shown in FIGS. 2 and 3, fixed sloping bench 6 is a fixed construction that can be located in any platform on the highway. The inclined surface of the fixed construction can load and/or unload the vehicle. When the truck is parking in a platform of the highway, the vehicle 4 can get on and off the truck through the inclined surface. FIG. 2 is an example to show how vehicle 4 gets on the fixed sloping bench from the back side of the truck. FIG. 3 is an example to describe how vehicle 4 gets off the truck through the fixed sloping bench.

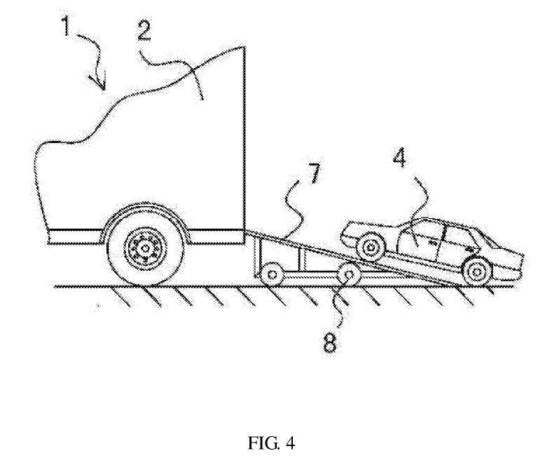

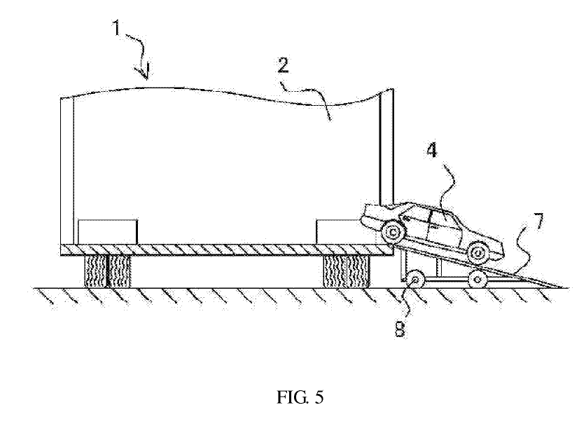

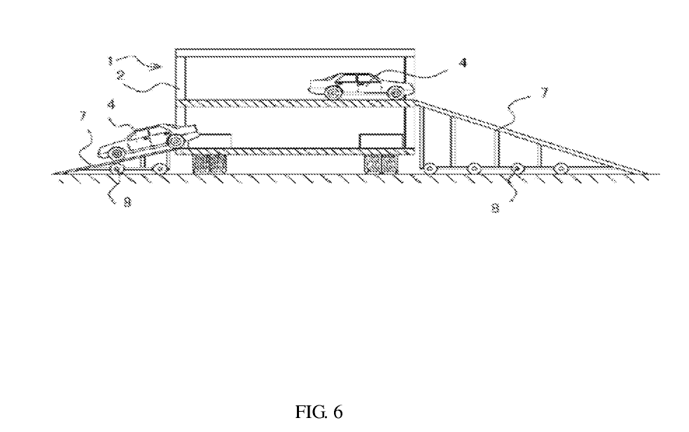

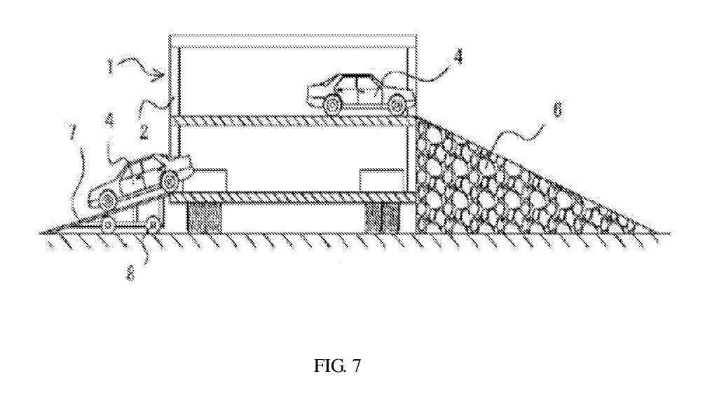

A moving sloping bench provides the same functions as what the fixed sloping bench does. The difference is that the moving sloping bench has rolling wheels under the supporting structure, so the bench can be movable. FIG. 4 is the diagram of vehicle loading process to the carrying truck with moving sloping bench. FIG. 5 is the diagram of vehicle unloading process from the carrying truck with moving sloping bench. FIG. 6 shows the diagram of vehicle unloading process to a carrying truck having two floors with two moving sloping benches. FIG. 7 describes the diagram of vehicle unloading process from a carrying truck having two floors with one fixed and one moving sloping benches.

The truck-carried sloping bench is a sloping bench carried by the truck itself. When the truck is stopped and parked in a platform, the carried vehicle can be loaded and unloaded from the truck-carried bench, which is stored inside the truck. No additional bench is needed from the platform for loading and/or unloading processes. After the loading and/or unloading processes are complete, the bench can be pulled back in the truck. Three different types of truck-carried sloping benches, that is, adjustable, folding, and hinged sloping benches, are presented in this invention.

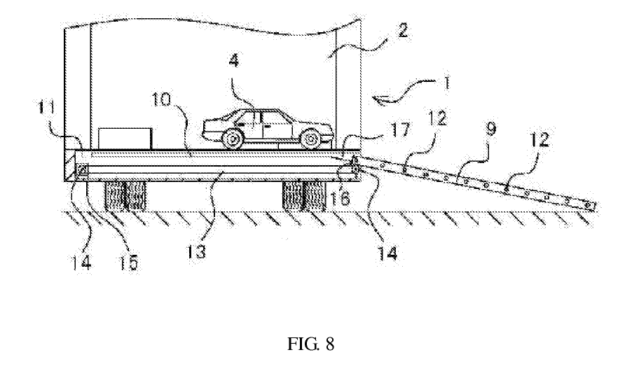

As shown in FIG. 8, the adjustable sloping bench has an adjustable plate 9, track 10, a transferring mechanism having a chain 13, two chain wheels 14, and the first electrical motor 15. The bottom of the carriage 2 has an accommodating space 11 for the sloping bench. The track is located at the top of the accommodating space 11. The adjustable plate 9 is located on top of the chain 13 and has guiding wheels 12. The guiding wheels 12 of the plate can rotate along the inner grooves of the track 10. The track has an inclined plane 17 on the end. One chain wheel 14 is connected with the electrical motor 15. The chain 13 has a drag point 16, which is linked with the adjustable plate 9. When the motor 15 rotates in a clockwise way continuously, the drag point can help move the adjustable plate 9 towards outside. Once the movement is close to the chain wheel 14, the last two guiding wheels 12 of the adjustable plate will enter the inclined plane 17 and the adjusting plate can form a sloping bench for loading and/or unloading vehicles. The plate itself is stiff enough to support the vehicles. When the motor rotates in an anticlockwise way, the drag point 16 will pull the adjustable plate back into the accommodating space 13 through the track 10. However, a vertical force is needed to lift one end of adjustable plate up where it touches the ground in order to make the pulling process happen. In the invention, the motor 15 can be in different formats such as an air cylinder, a hydraulic cylinder, or a DC motor. The stroke of the cylinder needs to meet the total movement range.

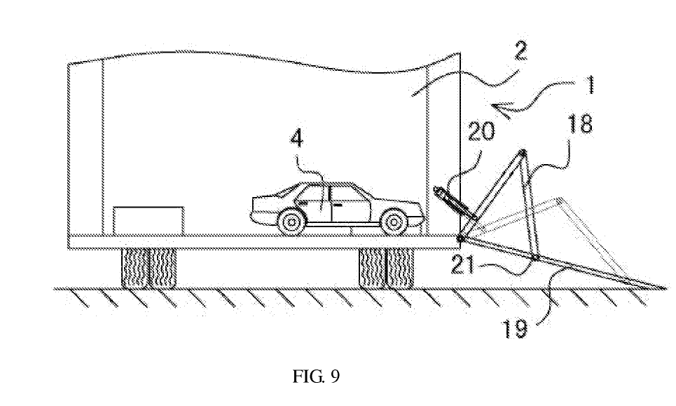

The folding sloping bench, as shown in FIG. 9, includes a folding plate 18, a guiding rail 19, and an air cylinder or a hydraulic cylinder 20. The folding plate 18 is combined with two hinged flat plates. One end of the folding plate 18 is hinged with the carriage 2, and the other end of the folding plate 18 has guiding wheels 21. The guiding wheels 21 can slide in the guiding rail 19. One end of the guiding rail is connected with the carriage 2 and the other touches the ground for loading and/or unloading processes. One end of the first air cylinder or hydraulic cylinder 20 is linked with the folding plate 18. When the folding sloping bench finishes the loading and/or unloading processes, the folding plate 18 and guiding rail 19 can be stored in the side or the back of the carriage 2. When it is in use, as shown in FIG. 9, the guiding rail is put down against the ground. The first air cylinder or hydraulic cylinder 20 pushes the folding plate slide along the guiding rail 19 by the guiding wheel 21 until the folding plate forms a slope with the ground. The guiding rail 19 will work as the supporting section. The guiding rail 19 can be folded and stored at the bottom of folding plate 18.

The folding sloping bench is to load and/or unload vehicles with both low height and short sloping distance and large height and long sloping distance. For the truck with two floor carriages, the quantity of the folding sloping bench can be one or two. If there are two folding sloping benches, one is set in the back and the other is set in the side of the carriage. Or both sloping benches can be set in the side of the truck. There is no limitation on the quantities of the sloping benches as long as these benches can help loading and/or unloading processes.

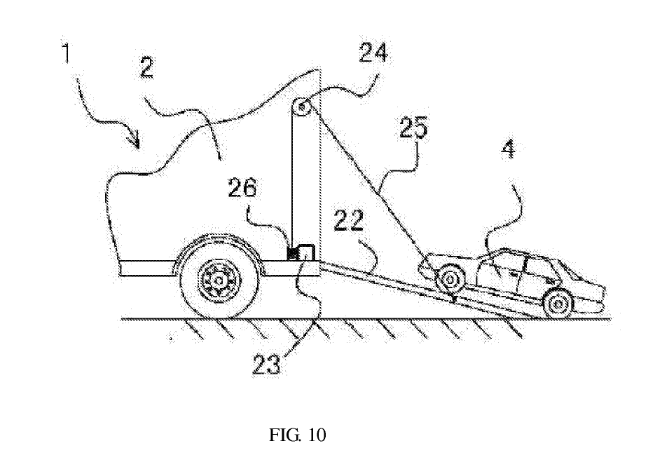

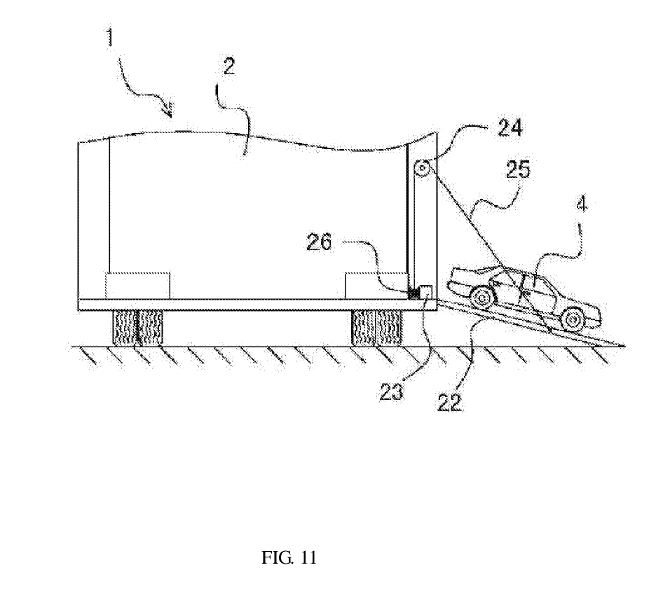

The hinged sloping bench is shown in the FIGS. 10 and 11. FIG. 10 shows that hinged sloping bench is located in the back of the carriage and FIG. 11 shows that hinged bench is stored in the side of the carriage. The hinged plate 22 is hinged with the carriage. As the hinged plate is put down against the ground, it will work as the sloping bench. When the hinged plate completes the loading and/or unloading process, it can be pulled back by an electrical motor 23, as shown in FIG. 10. When the electrical motor 23 rotates, it can pull back or release the rope that wraps around the rolling wheel 26. There is a fixed pulley 24 to guide the wire or rope 25 in the vertical direction. The electrical motor 23 here is just one embodiment. An alterative for the motor can be an air cylinder or hydraulic cylinder that can be used to push and pull the hinged plate 22.

The hinged sloping bench is suitable for loading and/or unloading processes with low height and short sloping distance. For the carriages located in the same floor, the quantity of the hinged sloping bench can be one or two. One can be set in the back and the other can be stored in the side, or both can be stored in the side of the truck. There is no limitation on the quantities of the hinged sloping bench as long as these benches can help the loading and/or unloading processes.

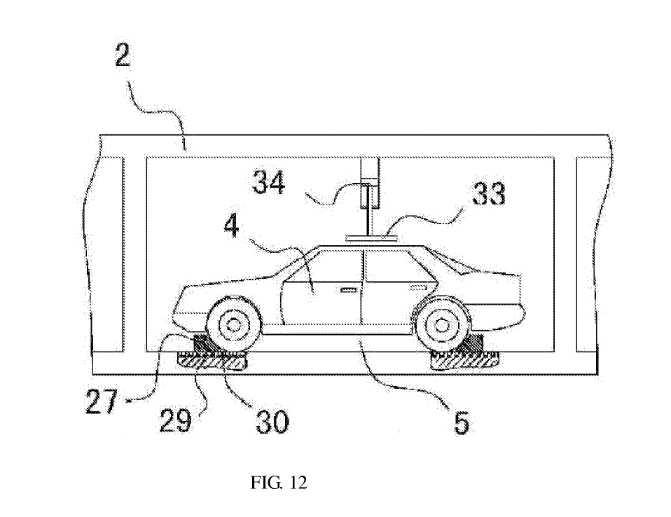

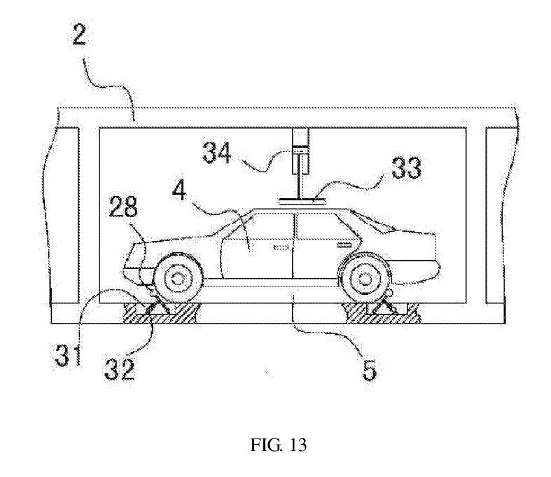

As shown in FIGS. 12 and 13, the position-setting setup is to fix the vehicle. The position-setting setup has one setup to fix tire of the carried vehicle and another setup to hold the vehicles from the roofs. The setup to fix the tire can be a wedge block 27 or a blocking rod 28. The wedge block 27 can be moved manually. The blocking rod can be rotated along a pivot driven by an air or hydraulic cylinder. The sloping surface of the wedge block 27 or the surface of blocking rod 28 is in contact with the wheel surface so that the vehicle 4 can be locked. The wedge block is movable and has convex teeth 29. The ground of the carriage near the wheel has concave-shaped cut 30. When the convex teeth are inserted into the concave-shaped cut 30, the wedge block 27 cannot be moved any more. The blocking rod is located in the concave space 31. The second cylinder or hydraulic cylinder 32 is set in the concave space 31 as well. When the vehicle is parking in vehicle parking space 5, the second air cylinder or hydraulic cylinder can push the blocking rod so that it can be in contact with the wheel surface. The setup to hold the vehicles from the top has a press plate 33 and a lifting structure 34. The lift structure is installed in the carriage 2 near the vehicle parking space 5. One side of the lift structure is linked with the press plate 33 so that the vehicle 4 can be fixed. The lift structure can be driven by air cylinder, hydraulic cylinder or chain transmission which is integrated with the lifting structure.

The switching lane can be set in any platform on the highway 36. The lane is used to change the direction of the truck. The switching lane can be in a format of tunnel under the ground or an overhead bridge 35 so that the truck can change the driving direction.

Parking platform 37 is set in any stop site on the highway 36 to load and/or unload vehicles. The platform has a gas station and/or charging station 38. The gas station can supply the fuel for the truck, and the charging station is to provide electricity for electrical driven truck. The electricity can be from either wind or solar energy.

All the above descriptions can only show the features and ideas of this invention so that the people in the same field can understand and realize the content of the invention. From the foregoing description, the present invention may be implemented in a variety of forms. Therefore, the embodiments of the present invention can be a large range and the true scope of the embodiments the present invention should not be so limited since other modifications will become apparent to the skilled practitioner upon a study of the drawings, specification, and claims.

1. A vehicle transportation system to transfer moving vehicles from one site to another site on the highway, comprising: a truck, sloping benches to load and/or unload vehicles, position-setting systems, switching lanes, and platforms.

2. The said truck according to claim 1, comprising: a power-driven device, a chassis, one room for the drivers, one room to work as V.I.P lobby, carriages, and electrical devices and accessories, wherein the said power-driven device is to provide power to move forward or stop the whole transportation system, the said chassis is to organize all components of the said system in claim 1 that can be driven by the power-driven device, the number of carriages can be one or more than one, a carriage can have one or two floors, and the electrical devices and accessories are to provide power supplies and electrical controls for the said vehicle transportation system.

3. The sloping benches according to claim 1, wherein the sloping benches can be fixed, moving, truck-carried sloping bench, or any combination of the above three and any of the said sloping bench has a supporting structure and a sloping surface for loading and/or unloading processes.

4. Any set of the position-setting systems according to claim 1, comprising: one setup to fix the tire of the said moving vehicles in claim 1 and another setup to fix the roof of the carried vehicle, wherein the said setup to fix the tire can be a wedge block assembly or a blocking rod assembly with air or hydraulic cylinder, the number of the wedge assembly or blocking rod assembly can be four per carried vehicle, the said another setup to fix the roof has a press plate and a lifting structure, and the number of setup to fix the roof is one per carried vehicle.

5. The said switching lanes according to claim 1, wherein the said lanes are to change the driving direction of the said truck and any lane can be either in a format of tunnel under the ground or an overhead bridge.

6. The said platforms according to claim 1, comprising: a gas station or charging station, wherein the gas station can supply the fuel for the truck , the charging station can provide electricity for the whole transportation system, and the electricity can be from in the format of either wind or solar energy.

7. The said power-driven device according to claim 2, wherein the device can be either internal combustion or an electro-motor engine, and the internal combustion engine can be either diesel or gasoline engine.

8. The fixed sloping bench according to claim 3, wherein the said supporting structure of the said bench is a fixed ground construction and the said fixed sloping bench can be located in any of the said platforms as claim 1.

9. The moving sloping bench according to claim 3, wherein the supporting structure of the said bench has rolling wheels which make the moving sloping bench movable and the said moving sloping bench is located in the said platforms in claim 1.

10. The truck-carried sloping bench according to claim 3, wherein the said truck-carried sloping bench is stored inside an accommodating space of the said truck and can be an adjustable, folding, hinged sloping bench, or any combination of the above three.

11. The said wedge block assembly according to claim 4, comprising a moveable wedge block with concave-shaped cut and convex teeth engraved in the said carriage in claim 2, wherein the concave-shaped cut and convex teeth both block one tire of the said vehicles in claim 1.

12. The said blocking rod assembly according to claim 4, comprising: a rod linked with one said carriage in claim 2 by a pivot, an air or hydraulic cylinder, and a concave space in the carriage, wherein the said cylinder can push or pull the said rod to lock one tire of the said vehicles in claim 1 by rotating along the said pivot, and the said rod, pivot and cylinder are all located in the said concave space.

13. The said lifting structure according to claim 4, wherein one end of said lifting structure is installed with one said carriage in claim 2 and an integrated air or hydraulic cylinder with the lifting structure can push or pull the said press plate against the roof of any of the said vehicles in claim 1.

14. The said adjustable sloping bench according to claim 10, comprising: an adjustable plate with guiding wheels, a track with inner grooves, and a transferring mechanism, wherein the adjustable plate is driven by the said transferring mechanism, the track has an inclined plane on the end to allow the said adjustable plate move down to the ground and to be pulled back into the said accommodating space in claim 10, the said guiding wheels rotate along the inner grooves of the said track, and the said adjustable plate, transferring mechanism and track are all located in the said accommodating space in claim 10.

15. The said folding sloping bench according to claim 10, comprising: two plates hinged in the middle, guiding wheels, guiding rail, an air cylinder or hydraulic cylinder, wherein two hinged folding plates can be pushed or pulled by the said cylinder and slide along the guiding rail by the said guiding wheels, one end of the one hinged plate is linked with one said carriage and one end of the other hinged plate having guided wheels touches the ground during loading and/or unloading processes, and one end of the guiding rail is hinged with the said carriage and other end touches the ground.

16. The said hinged sloping bench according to claim 10, comparing: a plate hinged with one said carriage in claim 2, a fixed pulley, a rotatable wheel with wires or ropes, and an electrical motor, wherein the said electrical motor can push or pull the hinged plate through the said wires or ropes guided by the fixed pulley and one end of the hinged plate touches the ground during loading and/or unloading processes.

17. The said adjustable, folding or hinged sloping benches according to claim 10, wherein the above said benches can be located in the back or side of the said truck and the quantities of these benches can be one or more than one.

18. The said transferring mechanism according to claim 14, comprising a chain with a snap point, two chain wheels, one electrical motor, wherein the snap point is linked the adjustable plate with the chain so that the chain wheels can move the adjustable plate in and out of the said accommodating space in claim 10 through the said inclined plane in claim 14, the power to move the plate is provided by the said chain, chain wheels and the electrical motor, and the guiding wheels of the adjustable plate move along the inner grooves of the said track.
